(19) United States
(12) Patent Application Publication
(10) Pub. No.: US 2026/0073561 A1
(43) Pub. Date: Mar. 12, 2026

(54) METEOROLOGICAL MEASUREMENT DEVICE

(71) Applicant: Murata Manufacturing Co., Ltd., Kyoto-fu (JP)

(72) Inventors: Yusaku MURAKAMI, Nagaokakyo-shi (JP); Yoshifumi WADA, Nagaokakyo-shi (JP); Hiroki MURAMOTO, Nagaokakyo-shi (JP)

(73) Assignee: Murata Manufacturing Co., Ltd., Kyoto-fu (JP)

(21) Appl. No.: 19/390,094

(22) Filed: Nov. 14, 2025

Related U.S. Application Data
(63) Continuation of application No. PCT/JP2024/009091, filed on Mar. 8, 2024.

(30) Foreign Application Priority Data
May 18, 2023 (JP) 2023-082558

(51) Int. Cl. G06T 7/73; G01W 1/04

(52) U.S. Cl. CPC G06T 7/75; G01W 1/04; G06T 2207/10048; G06T 2207/20081; G06T 2207/20084; G06T 2207/30192

(57) ABSTRACT

A maintenance-free meteorological measurement device that can accurately estimate the amount of falling rain, snow, or fog droplets without becoming clogged with debris or evaporation of water. A rain gauge includes a light guide plate and an infrared camera in a housing, and an AI computer that is an information processing device. The housing has a rectangular parallelepiped shape with an open top and an open bottom. The light guide plate unit is mounted on one side surface of the housing. The light guide plate unit includes an LED, a light guide plate, and a diffusion plate housed in a unit case. The infrared camera is on the other side surface of the housing that faces the one side surface across a space. The AI computer detects images of raindrops and estimates the amount of rainfall from the images of the raindrops using machine learning.

### CROSS-REFERENCE TO RELATED APPLICATIONS

This application claims benefit of priority to International Patent Application No. PCT/JP2024/009091, filed Mar. 8, 2024, and to Japanese Patent Application No. 2023-082558, filed May 18, 2023, the entire contents of each are incorporated herein by reference.

### BACKGROUND

### Technical Field

The present disclosure relates to a meteorological measurement device for measuring the amount of precipitation in the form of rain, snow, or fog droplets.

### Background Art

An example of this type of meteorological measurement device of the related art is disclosed in Japanese Unexamined Patent Application Publication No. 2008-157765, for example. This meteorological measurement device includes, installed in a support, a light source, a light-emitting mechanism consisting of a collimating lens that converts light emitted from the light source into parallel light, a condensing lens disposed a certain distance from the collimating lens, and a light-receiving mechanism consisting of an image sensor that receives light that has passed through the condensing lens and outputs image data. The support includes a roughly U-shaped arm member and a base member that hangs down from the center of the arm member and is installed on the ground or another surface. The light-emitting mechanism is provided in a light-emitting system housing formed at the upper end of one vertical bar of the arm member, and the light-receiving mechanism is provided in a light-receiving system housing formed at the upper end of another vertical bar of the arm member. The base member supports the arm member such that the arm member is able to rotate. Raindrops fall into the optical path of the parallel light, and image data in which only areas corresponding to the raindrops are depicted as black shadows is generated. Rainfall amount, raindrop size, and raindrop fall speed are calculated by processing this image data.

Another example of this type of meteorological measurement device of the related art is a rain gauge disclosed in Japanese Unexamined Patent Application Publication No. 2019-164134. This rain gauge includes a water collection section that collects rainwater that falls within a water receiving opening, a tubular section that includes a drip section that allows the rainwater collected in the water collection section to drip, a detection unit that detects the rainwater dripping from the drip section using infrared light, and a calculation unit that calculates the amount of rainfall based on the detection results.

Furthermore, in the related art, a flow rate estimation system for estimating the flow rate of a water current is disclosed in Japanese Unexamined Patent Application Publication No. 2022-99959, for example. This flow rate estimation system includes an imaging device that captures an image of the water current discharged from a nozzle, and an information processing device that estimates the flow rate of the water current based on the image captured by the imaging device. The information processing device includes an image acquiring unit that acquires an image of a water current, an estimation unit that estimates the flow rate of the water current based on the acquired image using machine learning, and an output unit that outputs the estimation result.

### SUMMARY

The meteorological measurement device of the related art disclosed in Japanese Unexamined Patent Application Publication No. 2008-157765 includes a mechanical mechanism, which is equipped with movable parts, in which an arm member including a light-emitting mechanism and a light-receiving mechanism is rotatably supported on a base member. Therefore, when operating the meteorological measurement device, maintenance is required, as in the case of a tipping bucket-type rain gauge that includes a tipping bucket as a mechanical mechanism.

Furthermore, in the rain gauge disclosed in Japanese Unexamined Patent Application Publication No. 2019-164134, if the detection unit becomes clogged with leaves or debris etc., the infrared light is obstructed from reaching the raindrops, making it impossible to accurately determine the amount of rain. Furthermore, since the detection unit is designed to detect raindrops that gradually drip from the drip section, when the amount of precipitation is small, the raindrops in the drip section will evaporate, making it impossible to accurately determine the amount of rainfall.

Furthermore, the flow rate estimation system disclosed in Japanese Unexamined Patent Application Publication No. 2022-99959 detects the flow of water discharged from a nozzle. Therefore, the flow rate estimation system cannot detect the amount of rain, snow, or fog droplets falling from the sky.

The present disclosure has been made in view of the above, and provides a meteorological measurement device including a housing having an open top; a light source provided on one side surface of the housing and configured to radiate light into a space formed inside the housing below the top; and an imaging device provided on another side surface of the housing, which faces the one side surface across the space, and configured to capture an image of the light radiated from the light source. Also, the meteorological measurement device includes an information processing device including an image detection means configured to detect an image of rain, snow, or fog droplets falling through the space via the top and blocking the light radiated from the light source from an image captured by the imaging device, and a precipitation amount estimation means configured to learn a correlation between the image detected by the image detection means and a measured amount of falling droplets through machine learning, and estimate the amount of falling droplets from the image.

According to this configuration, since there are no moving parts in a mechanical mechanism of the device, unlike the meteorological measurement device disclosed in the above-mentioned Japanese Unexamined Patent Application Publication No. 2008-157765 of the related art or a tipping bucket rain gauge commonly used to measure rainfall, no maintenance is required when operating the device.

Furthermore, because a large space can be formed within the housing below the top, there is no risk of the area where raindrops are detected becoming clogged with leaves or debris, as in the rain gauge of the related art disclosed in Japanese Unexamined Patent Application Publication No. 2019-164134. Furthermore, because the amount of falling droplets is estimated using machine learning based on an image formed by irradiating the droplets with light, there is no risk of the raindrops evaporating and the amount of rainfall not being determined correctly, as in the rain gauge of the related art disclosed in Japanese Unexamined Patent Application Publication No. 2019-164134.

Therefore, the device is maintenance-free and there is no need to worry about clogging with leaves or debris or evaporation of water, and the device can learn and accurately estimate the amount of falling rain, snow, or fog droplets using machine learning.

According to the present disclosure, a meteorological measurement device can be provided that is maintenance-free and can accurately estimate the amount of falling rain, snow, or fog droplets without concerns about clogging with leaves or debris or evaporation of water.

### BRIEF DESCRIPTION OF THE DRAWINGS

FIG. 1A is an external perspective view of a rain gauge according to an embodiment of the present disclosure, and FIG. 1B is a vertical sectional view of the rain gauge;

FIG. 2 is a block diagram of a rain gauge according to an embodiment;

FIG. 3 is a general flowchart illustrating an outline of precipitation amount estimation processing performed by an AI computer constituting a rain gauge according to an embodiment;

FIG. 4 is a flowchart illustrating the details of raindrop extraction processing performed by an image detection means in Step 101 in FIG. 3;

FIG. 5 is a flowchart illustrating processing for detecting rainfall intensity detected by a raindrop sensor in Step 101 in FIG. 3;

FIG. 6 is a table illustrating, in time series, average values per minute of various data obtained by the raindrop extraction processing illustrated in FIG. 4 and the rainfall intensity detection processing illustrated in FIG. 5; and

FIG. 7 is a graph illustrating an example of the correlation between the number of raindrop images and the amount of precipitation obtained by machine learning performed by an AI computer included in a rain gauge according to an embodiment.

### DETAILED DESCRIPTION

Next, an embodiment of a meteorological measurement device of the present disclosure will be described.

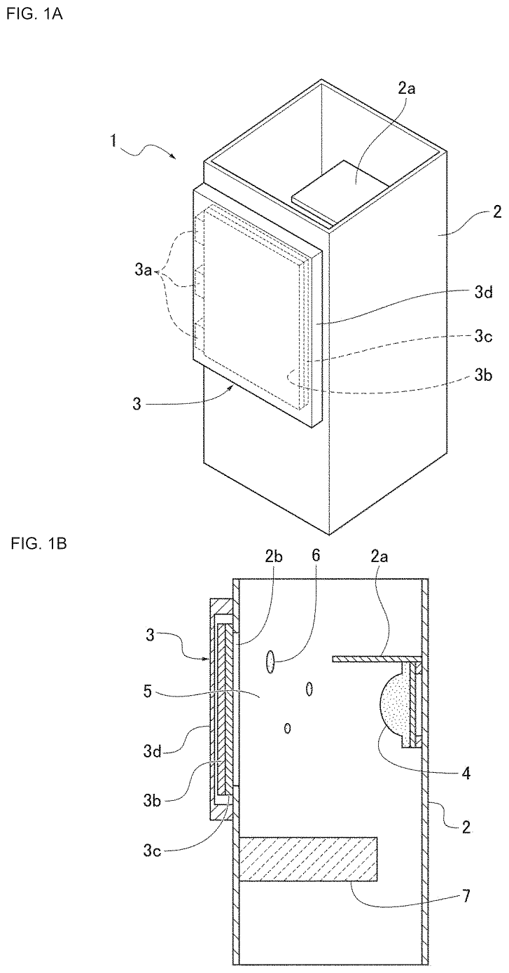

FIG. 1A is an external perspective view of a rain gauge 1 according to an embodiment in which a meteorological measurement device of the present disclosure is applied to a rain gauge, and FIG. 1B is a vertical sectional view of the rain gauge 1.

The rain gauge 1 is configured by providing a light guide plate unit 3 and an infrared camera 4 in a housing 2, and providing a single board computer (not illustrated) near the housing 2.

The housing 2 has a rectangular parallelepiped shape with an open top and an open bottom, a width of 320 mm, a depth of 375 mm, and a height of 380 mm, and is composed of resin or the like. The light guide plate unit 3 is provided on one side surface of the housing 2. The light guide plate unit 3 is configured by housing light-emitting diodes (LEDs) 3a, which constitute a light source, a light guide plate 3b, and a diffusion plate 3c in a unit case 3d.

Multiple LEDs 3a are provided at the side of the light guide plate 3b. Each LED 3a emits infrared light in a wavelength range (near-to-far infrared) close to the absorption wavelength of water and where sunlight is significantly attenuated, e.g., near-infrared light with a wavelength of 940 nm. The light guide plate 3b and the diffusion plate 3c are provided at the light-exiting side of the LEDs 3a. Near-infrared light entering the side of the light guide plate 3b travels along a light guide path extending through the entire interior of the light guide plate 3b, resulting in surface emission of the light from a front surface of the light guide plate 3b, which faces a rear surface of the diffusion plate 3c. The diffusion plate 3c diffuses the light emitted from the light guide plate 3b in a planar shape, and emits uniform light from a rectangular opening 2b in the housing 2. Therefore, the near-infrared light emitted from the LEDs 3a passes through the light guide plate 3b and the diffusion plate 3c, and a space 5 formed inside the housing 2 below the top of the housing 2 is irradiated with near-infrared light. When raindrops 6 fall into the space 5, the raindrops 6 pass through this near-infrared light.

The infrared camera 4, which constitutes an imaging device, is provided on another side surface of the housing 2. The other side surface faces the one side surface across the space 5. The infrared camera 4 detects and visualizes the infrared light radiated into the space 5, and captures images of near-infrared light radiated from the LEDs 3a. The housing 2 includes a canopy 2a above the infrared camera 4, which protrudes into the space 5, and blocks the raindrops 6 falling into the space 5. In addition, a raindrop sensor 7 is installed below the space 5 of the housing 2 in order to measure the amount of rainfall from the falling raindrops 6. This raindrop sensor 7 is only needed when installing the rain gauge 1 and when updating an algorithm, which is described later.

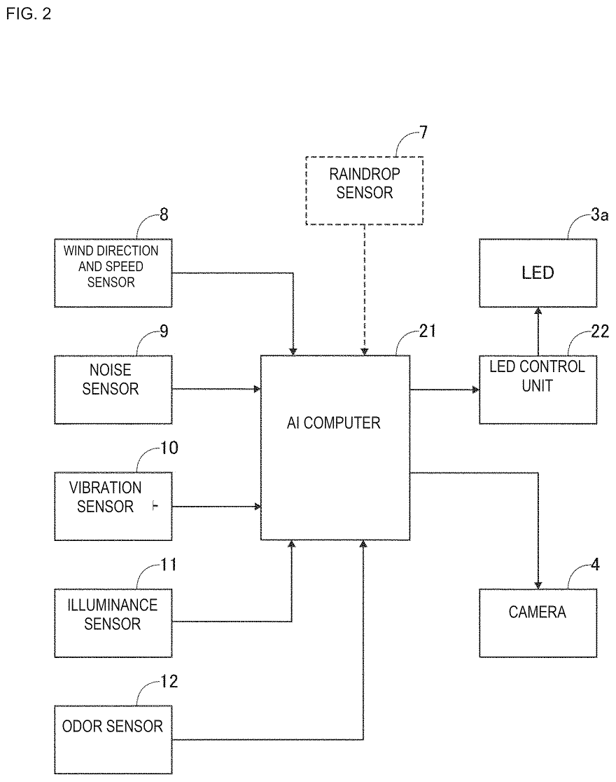

FIG. 2 is a block diagram of the rain gauge 1 according to an embodiment.

An AI computer 21 is a single-board computer such as NVIDIA's Jetson Nano. The AI computer 21 is electrically connected to an LED control unit 22, which controls the light emission of the LEDs 3a, and to the infrared camera 4. The AI computer 21 is electrically connected to the raindrop sensor 7, a wind direction and speed sensor 8, a noise sensor 9, a vibration sensor 10, an illuminance sensor 11, and an odor sensor 12, etc. These various sensors are provided in the housing 2, etc., in order to detect the environment around the rain gauge 1.

The wind direction and speed sensor 8 detects the wind direction and speed around the housing 2. The noise sensor 9 detects noise occurring around the housing 2 and in the housing 2 itself. The vibration sensor 10 detects vibrations occurring around the housing 2 and in the housing 2 itself. The illuminance sensor 11 detects the illuminance around the housing 2. The odor sensor 12 detects odors around the housing 2. It is not necessary to provide all of these sensors 8 to 12, and the sensors may be selected and used as appropriate.

The AI computer 21 includes a GPU, CPU, memory, storage, etc., and constitutes an information processing device. The information processing device includes an image detection means and a precipitation amount estimation means. The image detection means detects, from video captured by the infrared camera 4, images of rain, snow or mist droplets falling through the top into the space 5 and blocking the near-infrared light emitted from the LEDs 3a. In this embodiment, the image detection means detects images of the raindrops 6. Images of these droplets are captured by the infrared camera 4 as clear black images of the areas where the drops are present due to the rain, snow or fog droplets absorbing the near-infrared light. The precipitation amount estimation means uses machine learning to learn the correlation between images detected by the image detection means and the amount of falling raindrops measured as a reference by the raindrop sensor 7, and estimates the amount of falling raindrops from the images. In this embodiment, the precipitation amount estimation means estimates the amount of rainfall from images of the raindrops 6.

The precipitation amount estimation means includes an algorithm creation means and an algorithm updating means. The algorithm creation means uses machine learning to learn the correlation between images detected by the image detection means and measured amounts of falling droplets, and creates an algorithm to be used to estimate the amount of falling droplets. When any one of the sensors 8 to 12 is connected to the AI computer 21, the algorithm creation means creates the algorithm by using machine learning to learn the correlation between the detected images and measured amounts of falling droplets while taking into account the detection information detected by the sensors 8 to 12 being used. The algorithm updating means uses images newly detected by the image detection means to re-learn the correlation between the images of droplets and the amounts of falling droplets, and updates the algorithm. This re-learning of the algorithm is performed by acquiring precipitation amount data at various locations.

The precipitation amount estimation means further includes an image complementary processing means. The image complementary processing means performs complementary processing for reducing momentary fluctuations in the number, area, or shape of images detected in time series by the image detection means, in post-processing after image detection, based on information on the images before and after the fluctuations. The precipitation amount estimation means uses the images subject to the complementary processing by the image complementary processing means to learn the correlation between the images of droplets and the amounts of falling droplets through machine learning.

The image detection means, precipitation amount estimation means, algorithm creation means, algorithm updating means, and image complementary processing means are realized by software processing in accordance with the programs of the AI computer 21.

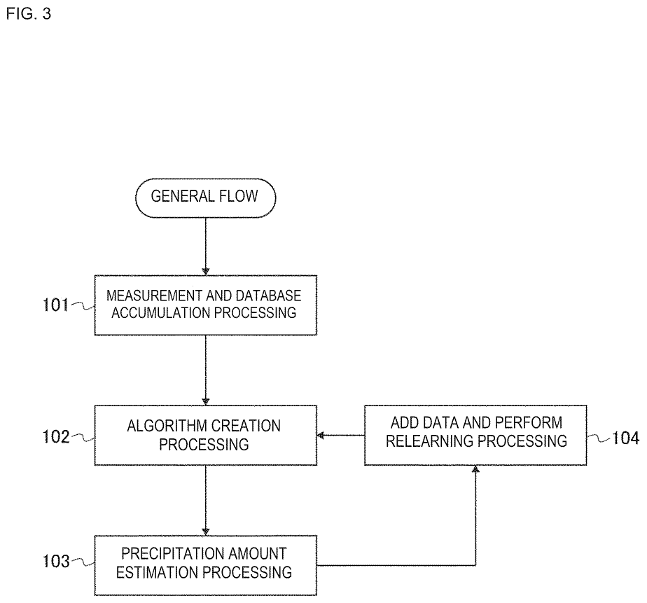

FIG. 3 is a general flowchart illustrating an outline of precipitation amount estimation processing performed by the AI computer 21. This precipitation amount estimation processing is performed when the rain gauge 1 is installed and whenever the algorithm is updated thereafter as appropriate.

First, in Step 101, images of the raindrops 6, which are captured by the infrared camera 4 by irradiating the space 5 with near-infrared light from the LEDs 3a, are measured by the image detection means. Measurements are taken at multiple locations and at multiple times. The various measured images are stored in the form of a database in a memory of the AI computer 21, along with the amounts of precipitation measured by the raindrop sensor 7 and sensor data detected by the various sensors 8 to 12.

Next, in Step 102, an algorithm for calculating the amounts of precipitation from the images of raindrops 6 detected by the image detection means is created by the algorithm creation means through supervised machine learning. At this time, the AI computer 21 automatically extracts rain-related characteristics from the rain captured in the video, and the algorithm is created based on more diverse information than was previously the case.

Next, in Step 103, the amount of precipitation is calculated by the precipitation amount estimation means from images of the raindrops 6 obtained during a certain specific period of time using the database accumulated in Step 101 and the algorithm created in Step 102. This calculation of the amount of precipitation can be performed in real time.

Next, in Step 104, re-learning is performed by machine learning in which newly obtained images of the raindrops 6 are added. Next, Step 102 is performed again, and an algorithm that reflects the results of the re-learning performed in Step 104 is recreated by the algorithm updating means so that the previously created algorithm is constantly updated. Thereafter, the processing of Steps 102, 103, and 104 is repeatedly executed, and the amount of precipitation is calculated using the updated algorithm.

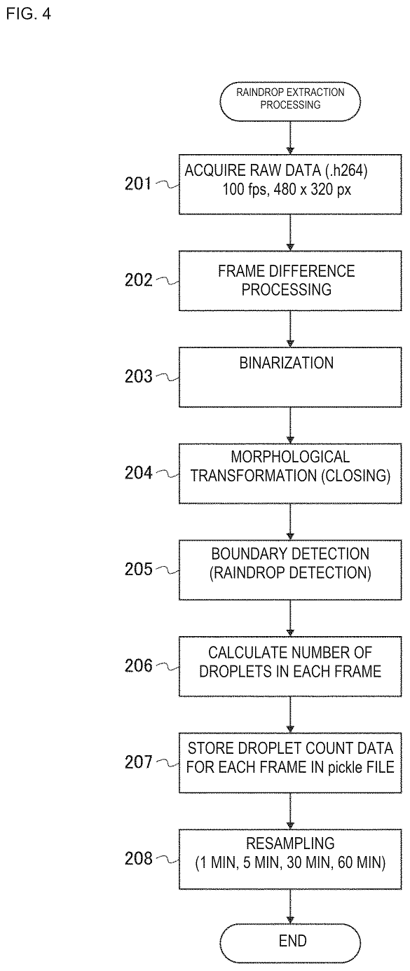

FIG. 4 is a flowchart illustrating the details of the raindrop extraction processing performed by the image detection means in Step 101.

First, in Step 201, raw data (.h264) of the video captured by the infrared camera 4 is obtained from the database stored in the memory. The video is captured at 100 frames per second with a pixel count of 480×320 pixels.

Next, in Step 202, frame difference processing is performed on the raw data acquired in Step 101 to detect moving images, i.e., images of the raindrops 6. Then, in the next Step 203, the detected image data of the raindrops 6 is converted into binarized data.

Next, in Step 204, closing morphological transformation processing is performed on the binarized data. In this closing processing, expansion processing is performed on an image of the raindrops 6, which is the object, and then contraction processing is performed to fill in small black dots contained in the object.

Next, in Step 205, object boundary detection processing is performed on the binarized data that has been subjected to the closing processing, and images of the raindrops 6 are detected. Next, in Step 206, processing is performed to calculate the number of images of the raindrops 6 in each frame, i.e., the number of droplets.

Next, in Step 207, the number of droplets in each frame is saved in a pickle file, and the numbers of droplets are stored in chronological order. At the same time, processing is performed in which the sensor data detected at each timing by the wind direction and speed sensor 8, the noise sensor 9, the vibration sensor 10, the illuminance sensor 11, and the odor sensor 12 is also stored in the database in chronological order along with the number of droplets, in accordance with the timing of the detection of the images of the raindrops 6.

Next, in Step 208, resampling processing is performed to match the sampling rate of the raindrops 6 in the rainfall intensity sensor data measured by the raindrop sensor 7 as described below with the sampling rate of the images of the raindrops 6 extracted in the raindrop extraction processing. In the video data, which is captured at 100 frames per second by the infrared camera 4, one frame image is obtained every 0.01 seconds. In the resampling processing, the average number of images of the raindrops 6 appearing per frame, for example, per 1 minute, 5 minutes, 30 minutes, or 60 minutes, is calculated in accordance with the calculation rate of the raindrops 6 in the rainfall intensity sensor data. Furthermore, in accordance with the resampling rate of this number of droplets, the average value per frame (per 0.01 seconds) of the information detected, for example, per 1 minute, 5 minutes, 30 minutes, or 60 minutes is calculated for the sensor data from the various sensors 8 to 12.

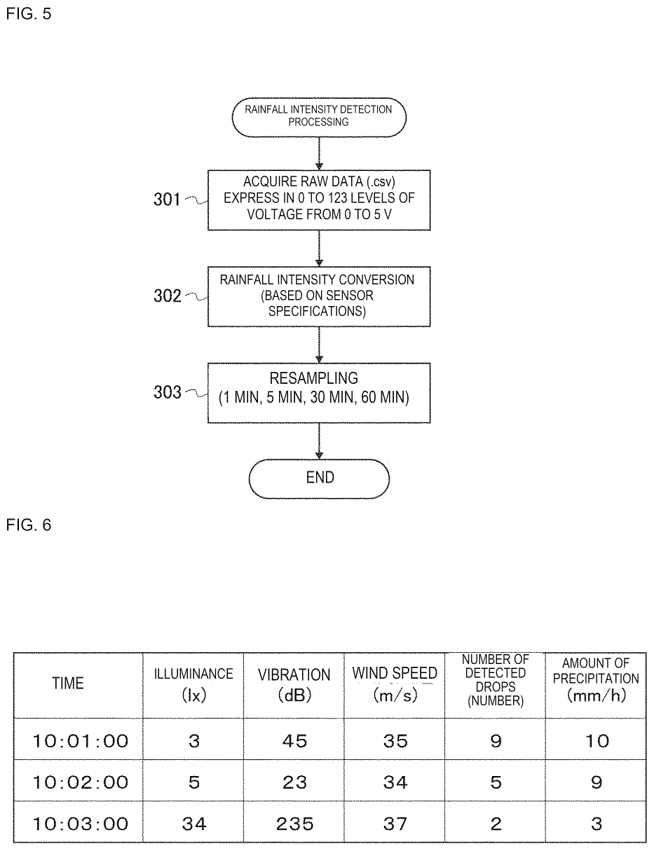

FIG. 5 is a flowchart illustrating processing of detecting the rainfall intensity detected by the raindrop sensor 7. This rainfall intensity detection processing is also performed in Step 101 of FIG. 3.

First, in Step 301, the AI computer 21 performs processing to acquire raw data (.csv) obtained at each timing from the raindrop sensor 7. This raw data is expressed in 0 to 123 levels of voltage from 0 to 5 V.

Next, in Step 302, the rainfall intensity is obtained based on the sensor specifications of the raindrop sensor 7 in accordance with the 0 to 123 levels of voltage acquired in Step 301.

Next, in Step 303, resampling processing is performed for the rainfall intensity (amount of precipitation) obtained in Step 302. In this resampling processing, the average value per frame of the rainfall intensity detected, for example, per 1 minute, 5 minutes, 30 minutes, or 60 minutes is calculated in accordance with the sampling rate of the images of the raindrops 6 extracted in the raindrop extraction processing.

FIG. 6 is a table illustrating, in time series, the average values per minute of various data obtained by the raindrop extraction processing illustrated in FIG. 4 and the rainfall intensity detection processing illustrated in FIG. 5, with the granularity of the image data of the raindrops 6 and the rainfall intensity data adjusted by the resampling processing performed in 208 and 303. These pieces of data are stored as a database in the memory of the AI computer 21.

In the figure, the sensor data of illuminance [lx], vibration [dB], and wind speed [m/s] obtained by the illuminance sensor 11, the vibration sensor 10, and the wind direction and speed sensor 8, as well as the number of detected particles [number], which is the number of images of the raindrops 6 detected in the raindrop extraction processing, and the amount of precipitation [mm/h] detected in the rainfall intensity detection processing are illustrated in a table for each time.

Based on such data accumulated in the processing of Step 101 in FIG. 3, the precipitation amount estimation means embodied by the AI computer 21 learns, through machine learning the correlation between the images of the raindrop 6 detected by the image detection means and the rainfall intensity (amount of precipitation) of the raindrops 6 measured by the raindrop sensor 7 in the processing of Step 102, and estimates the amount of precipitation of the raindrops 6 from the images in processing of Step 103.

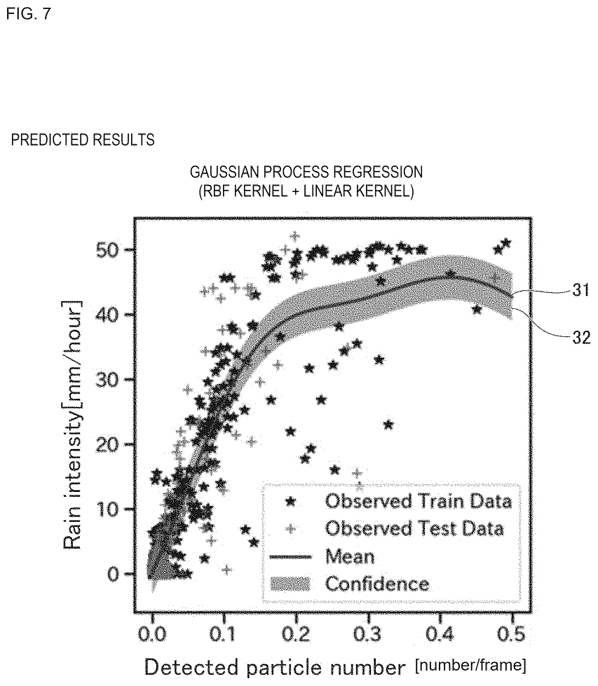

FIG. 7 is a graph illustrating an example of the correlation between the number of images of raindrops 6 and the amount of precipitation obtained by this machine learning.

The horizontal axis of the graph is the number of detected raindrops 6 (Detected particle number) [number/frame], and the vertical axis is the rainfall intensity (Rain intensity) [mm/hour] obtained from the output of the raindrop sensor 7. Furthermore, the plots marked with stars (★) and crosses (+) represent the detected data of the images used in machine learning, with the plots marked with stars representing the training data (Observed Train Data) and the plots marked with crosses representing the test data (Observed Test Data).

Furthermore, curve 31 represents the average value (Mean) of the learning model function that expresses the correlation between the number of detected particles and rainfall intensity, obtained from the learning data, and area 32, which is represented by a width centered on characteristic line 31, represents the reliability (Confidence) of the data. In areas where there is a large distribution of learning data and the number of detected particles on the horizontal axis is small, the width of area 32 is represented as small, indicating that the data has high reliability. In areas where there is a small distribution of learning data and the number of detected particles on the horizontal axis is large, the width of area 32 is represented as large, indicating that the data has low reliability.

The prediction of rainfall intensity by machine learning is performed by learning the correlation between the images of the raindrops 6 detected by the image detection means and the amount of precipitation at the time of detection using machine learning, and then performing regression analysis. In this embodiment, this regression analysis is performed using Gaussian process regression, in which the probability distribution of a learning model function that represents the correlation between the number of detected particles and rainfall intensity is obtained in the form of a Gaussian process. In addition, in the Gaussian process regression, both the RBF kernel and the linear kernel are used together as the kernel function. Note that the prediction of rainfall intensity by machine learning is not limited to Gaussian process regression, and may also be performed using image classification architectures such as a Visual Geometry Group (VGG) and a Residual Network (ResNet).

As illustrated in the graph of FIG. 7, the correlation between the number of detected particles and rainfall intensity is obtained, and from the detected number of raindrops 6 obtained by the image detection means in a specific period, the amount of precipitation is calculated by the precipitation amount estimation means based on the curve 31 in Step 103 of FIG. 3.

According to the rain gauge 1 of this embodiment, since the mechanical mechanism of the device does not contain any moving parts, unlike the meteorological measurement device of the related art disclosed in Japanese Unexamined Patent Application Publication No. 2008-157765 or the tipping bucket rain gauge commonly used to measure rainfall, no maintenance is required when operating the device.

Furthermore, because the space 5 formed inside the housing 2 below the top can be made large, there is no risk of leaves or debris clogging the area where raindrops are detected, as in the rain gauge of the related art disclosed in Japanese Unexamined Patent Application Publication No. 2019-164134. Furthermore, because the amount of falling raindrops 6 is estimated by machine learning based on the images formed by shining light onto the droplets, there is no risk of raindrops evaporating and the amount of rainfall not being determined correctly, as in case of the rain gauge of the related art disclosed in Japanese Unexamined Patent Application Publication No. 2019-164134.

This makes it possible to accurately estimate the amount of falling raindrops 6 by learning through machine learning, without the need for maintenance or concerns about clogging with leaves or debris or evaporation of water.

The rain gauge disclosed in Japanese Unexamined Patent Application Publication No. 2019-164134 can only count the number of raindrops falling from the drip section, whereas the rain gauge 1 according to this embodiment uses image data to detect images of the raindrops 6, and therefore it is possible to detect various information such as the number, size, and falling speed of the raindrops 6 and correlate these kinds of information with the amount of precipitation to predict the amount of precipitation. Furthermore, the meteorological measurement device disclosed in Japanese Unexamined Patent Application Publication No. 2008-157765 can extract features such as the size, falling speed, and shape of raindrops, but is unable to correlate this information with the amount of precipitation.

Furthermore, in the rain gauge 1 according to this embodiment, the amount of falling raindrops 6 is estimated using an algorithm created by the algorithm creation means using rainfall data obtained under various conditions in the processing of Step 102 in FIG. 3. Then, in the processing of Step 104, the algorithm is re-learned by the algorithm updating means using new images detected by the image detection means. This allows the amount of falling raindrops 6 to be estimated with even greater accuracy.

Furthermore, with the rain gauge 1 according to this embodiment, non-visual information such as wind direction and speed, noise, vibration, and odor detected around the housing 2 or in the housing 2 itself, or illuminance information, is added to the learning data for the machine learning performed by the algorithm creation means, and then the correlation between an image detected by the image detection means and the amount of falling raindrops 6 is estimated. This makes it possible to predict rainfall while taking into account changes in the surrounding conditions that could not previously be taken into account, and to estimate the correlation between images of the raindrops 6 and the amount of falling raindrops 6 in various environments, and to accurately estimate this correlation in each environment. This makes it possible to more accurately estimate the amount of falling raindrops 6 in each environment. This makes it possible to predict rainfall while taking into account differences in location, time, and the effect of the surroundings.

As a result, machine learning can be used to automatically extract rain-related characteristics from captured videos of rain, making it possible to calculate the amount of precipitation using a wider variety of information than was previously possible. For example, when the wind blows, the falling direction of the raindrops 6 and the number of observed raindrops 6 will also change, but it was not previously known how these characteristics would relate to the amount of precipitation. However, according to this embodiment, machine learning can be used to mechanically associate information on the falling direction and information on the number of raindrops 6 captured on video with the amount of precipitation.

Furthermore, in the rain gauge 1 according to this embodiment, complementary processing for reducing momentary fluctuations in the number, area, or shape of images detected in time series by the image detection means is performed by the image complementary processing means in post-processing after image detection based on information on images before and after the fluctuations. The correlation between images and the amounts of precipitation estimated by the precipitation amount estimation means is learned using images subjected to the complementary processing by the image complementary processing means.

For example, even if the amount of raindrops 6 falling into the space 5 of the rain gauge 1 decreases due to a momentary strong wind, the sensor data from the wind direction and speed sensor 8 and the image data of the raindrops 6 can be referenced in chronological order, and the image count data of the raindrops 6 detected as being fewer when the wind speed increases can be complemented based on information on images before and after the change, thereby correcting the estimated amount of precipitation when the wind speed increases. Therefore, the correlation between the images and the amount of precipitation can be estimated with high accuracy by the precipitation amount estimation means.

Furthermore, according to the rain gauge 1 of this embodiment, by using infrared light in a wavelength band close to the absorption wavelength of water to detect images of the raindrops 6, the infrared light emitted from the LEDs 3a is almost entirely absorbed by the raindrops 6, and the images of the raindrops 6 captured by the infrared camera 4 become clearer. Furthermore, by using infrared light in a wavelength band in which sunlight is greatly attenuated to detect images of the raindrops 6, the effects of sunlight shining on the housing 2 can be reduced and images of the raindrops 6 can be captured.

Therefore, with this configuration, it is possible to capture clear images of the raindrops 6 with little effect from sunlight. On the other hand, the meteorological measurement device disclosed in Japanese Unexamined Patent Application Publication No. 2008-157765 is strongly influenced by sunlight and other external light, and is unable to accurately determine the amount of rain, etc.

Furthermore, in the rain gauge 1 according to this embodiment, the light emitted from the LEDs 3a is converted into planar light by the light guide plate 3b and then converted into uniform planar light by the diffusion plate 3c. Therefore, the light emitted from the LEDs 3a is evenly radiated into the space 5 formed inside the housing 2 below the top. As a result, the light is evenly radiated onto the raindrops 6 falling into the space 5 between the light guide plate unit 3 and the infrared camera 4, and the infrared camera 4 captures images of the raindrops 6 without missing any of the raindrops 6. Therefore, the image detection means can accurately detect the images of the raindrops 6, and ultimately, the correlation between the images of the raindrops 6 and the amount of falling raindrops 6 can be accurately estimated.

The meteorological measurement device disclosed in Japanese Unexamined Patent Application Publication No. 2008-157765 requires an expensive telecentric lens as the collimating lens, which increases the price of the meteorological measurement device, whereas the rain gauge 1 according to this embodiment can be realized using the general light guide plate 3b and diffusion plate 3c, thereby reducing the product price.

Furthermore, according to the rain gauge 1 of this embodiment, the canopy 2a above the infrared camera 4 prevents raindrops 6 from falling onto the infrared camera 4. This makes it possible to eliminate the influence of raindrops 6 adhering to the infrared camera 4 on the images captured by the infrared camera 4.

In the above embodiment, the present disclosure has been described as being applied to the rain gauge 1 that detects images of the raindrops 6 in order to predict and estimate the amount of precipitation. However, the present disclosure is not limited to the raindrops 6, and can also be similarly applied to a meteorological measurement device that detects snow or fog particles in the same way as the raindrops 6 in order to predict and estimate the amount of falling snow or fog. In this case, substantially the same effects as those of the rain gauge 1 according to the above embodiment can be achieved.

To summarize the above, the present disclosure can be expressed as follows.
<1> A meteorological measurement device comprising a housing having an open top; a light source provided on one side surface of the housing and configured to radiate light into a space formed inside the housing below the top; and an imaging device provided on another side surface of the housing, the other side surface facing the one side surface across the space, and configured to capture an image of the light radiated from the light source. The meteorological measurement device also comprises an information processing device including an image detection means configured to detect an image of rain, snow, or fog droplets falling through the space via the top and blocking the light radiated from the light source from an image captured by the imaging device, and a precipitation amount estimation means configured to learn a correlation between the image detected by the image detection means and a measured amount of falling droplets through machine learning, and estimate the amount of falling droplets from the image.
<2> The meteorological measurement device according to <1>, wherein the precipitation amount estimation means includes an algorithm creation means configured to learn the correlation by machine learning and create an algorithm used to estimate the amount of falling droplets, and an algorithm updating means configured to update the algorithm by relearning the correlation through machine learning using the image newly detected by the image detection means.
<3> The meteorological measurement device according to <2>, comprising at least one sensor from among a wind direction and speed sensor that detects wind direction and wind speed around the housing, a noise sensor that detects noise occurring around the housing and in the housing itself, a vibration sensor that detects vibrations occurring around the housing and in the housing itself, an odor sensor that detects odors around the housing, and an illuminance sensor that detects illuminance around the housing. The algorithm creation means creates the algorithm by learning the correlation through machine learning while taking into account detection information detected by at least one of the sensors.
<4> The meteorological measurement device according to any one of <1> to <3>, wherein the precipitation amount estimation means includes an image complementary processing means configured to perform complementary processing to reduce momentary fluctuations in the number, area, or shape of the images detected in time series by the image detection means, in post-processing after the detection of the images, based on information on the images before and after the fluctuations, and learns the correlation by machine learning using the images subjected to the complementary processing by the image complementary processing means.
<5> The meteorological measurement device according to any one of <1> to <4>, wherein the light source emits infrared light in a wavelength band close to an absorption wavelength of water where attenuation of sunlight is large, and the imaging device is an infrared camera that detects and visualizes infrared light.
<6> The meteorological measurement device according to any one of <1> to <5>, further comprising a light guide plate configured to cause the light emitted from the light source to be emitted in a surface-emission manner, and a diffusion plate configured to diffuse the light emitted from the light guide plate, the light guide plate and the diffusion plate disposed on a light emission side of the light source.
<7> The meteorological measurement device according to any one of <1> to <6>, wherein the housing includes a canopy above the imaging device that protrudes into the space and prevents the droplets from falling into the space.

What is claimed is:

1. A meteorological measurement device comprising:
a housing having an open top;
a light source on one side surface of the housing and configured to radiate light into a space inside the housing below the top;
an imager on an other side surface of the housing, the other side surface facing the one side surface across the space, and configured to capture an image of the light radiated from the light source; and
an information processor configured to detect an image of rain, snow, or fog droplets falling through the space via the top and blocking the light radiated from the light source from an image captured by the imaging device, and to learn a correlation between the image detected and a measured amount of falling droplets through machine learning, and estimate the amount of falling droplets from the image.

2. The meteorological measurement device according to claim 1, wherein
the information processor is further configured to
learn the correlation by machine learning and create an algorithm used to estimate the amount of falling droplets, and
update the algorithm by relearning the correlation through machine learning using the image newly detected.

3. The meteorological measurement device according to claim 2, further comprising:
at least one sensor from among a wind direction and speed sensor that is configured to detect wind direction and wind speed around the housing, a noise sensor configured to detect noise occurring around the housing and in the housing itself, a vibration sensor configured to detect vibrations occurring around the housing and in the housing itself, an odor sensor configured to detect odors around the housing, and an illuminance sensor configured to detect illuminance around the housing, and
wherein the information processor is further configured to create the algorithm by learning the correlation through machine learning while taking into account detection information detected by at least one of the sensors.

4. The meteorological measurement device according to claim 1, wherein
the information processor is further configured to perform complementary processing to reduce momentary fluctuations in a number, area, or shape of the images detected, in post-processing after the detection of the images, based on information on the images before and after the fluctuations, and to learn the correlation by machine learning using the images subjected to the complementary processing by the information processor.

5. The meteorological measurement device according to claim 1, wherein
the light source is configured to emit infrared light in a wavelength band close to an absorption wavelength of water where attenuation of sunlight is large, and
the imaging device is an infrared camera that is configured to detect and visualize infrared light.

6. A meteorological measurement device according to claim 1, further comprising:
a light guide plate configured to cause the light emitted from the light source to be emitted in a surface-emission manner, and a diffusion plate configured to diffuse the light emitted from the light guide plate, the light guide plate and the diffusion plate being on a light emission side of the light source.

7. The meteorological measurement device according to claim 1, wherein
the housing includes a canopy above the imaging device that protrudes into the space and is configured to prevent the droplets from falling into the space.

8. The meteorological measurement device according to claim 2, wherein
the information processor is further configured to perform complementary processing to reduce momentary fluctuations in a number, area, or shape of the images detected, in post-processing after the detection of the images, based on information on the images before and after the fluctuations, and to learn the correlation by machine learning using the images subjected to the complementary processing by the information processor.

9. The meteorological measurement device according to claim 3, wherein
the information processor is further configured to perform complementary processing to reduce momentary fluctuations in a number, area, or shape of the images detected, in post-processing after the detection of the images, based on information on the images before and after the fluctuations, and to learn the correlation by machine learning using the images subjected to the complementary processing by the information processor.

10. The meteorological measurement device according to claim 2, wherein
the light source is configured to emit infrared light in a wavelength band close to an absorption wavelength of water where attenuation of sunlight is large, and
the imaging device is an infrared camera that is configured to detect and visualize infrared light.

11. The meteorological measurement device according to claim 3, wherein
the light source is configured to emit infrared light in a wavelength band close to an absorption wavelength of water where attenuation of sunlight is large, and
the imaging device is an infrared camera that is configured to detect and visualize infrared light.

12. The meteorological measurement device according to claim 4, wherein
the light source is configured to emit infrared light in a wavelength band close to an absorption wavelength of water where attenuation of sunlight is large, and
the imaging device is an infrared camera that is configured to detect and visualize infrared light.

13. A meteorological measurement device according to claim 2, further comprising:
a light guide plate configured to cause the light emitted from the light source to be emitted in a surface-emission manner, and a diffusion plate configured to diffuse the light emitted from the light guide plate, the light guide plate and the diffusion plate being on a light emission side of the light source.

14. A meteorological measurement device according to claim 3, further comprising:
a light guide plate configured to cause the light emitted from the light source to be emitted in a surface-emission manner, and a diffusion plate configured to diffuse the light emitted from the light guide plate, the light guide plate and the diffusion plate being on a light emission side of the light source.

15. A meteorological measurement device according to claim 4, further comprising:
a light guide plate configured to cause the light emitted from the light source to be emitted in a surface-emission manner, and a diffusion plate configured to diffuse the light emitted from the light guide plate, the light guide plate and the diffusion plate being on a light emission side of the light source.

16. A meteorological measurement device according to claim 5, further comprising:
a light guide plate configured to cause the light emitted from the light source to be emitted in a surface-emission manner, and a diffusion plate configured to diffuse the light emitted from the light guide plate, the light guide plate and the diffusion plate being on a light emission side of the light source.

17. The meteorological measurement device according to claim 2, wherein
the housing includes a canopy above the imaging device that protrudes into the space and is configured to prevent the droplets from falling into the space.

18. The meteorological measurement device according to claim 3, wherein
the housing includes a canopy above the imaging device that protrudes into the space and is configured to prevent the droplets from falling into the space.

19. The meteorological measurement device according to claim 4, wherein
the housing includes a canopy above the imaging device that protrudes into the space and is configured to prevent the droplets from falling into the space.

20. The meteorological measurement device according to claim 5, wherein
the housing includes a canopy above the imaging device that protrudes into the space and is configured to prevent the droplets from falling into the space.
